(19) United States
(12) Patent Application Publication
(10) Pub. No.: US 2023/0273944 A1
(43) Pub. Date: Aug. 31, 2023

(54) NATURAL LANGUAGE RESPONSE GENERATION TO KNOWLEDGE QUERIES

(71) Applicant: COGNIUS AI PTE LTD, Singapore (SG)

(72) Inventor: Mundigala Arachchillage Isuru Suharshan Rajakaruna, Singapore (SG)

(73) Assignee: COGNIUS AI PTE LTD, Singapore (SG)

(21) Appl. No.: 18/114,623

(22) Filed: Feb. 27, 2023

Related U.S. Application Data
(60) Provisional application No. 63/314,765, filed on Feb. 28, 2022.

(51) Int. Cl. G06F 16/332; G06F 16/33; G06F 16/338; G06N 20/00

(52) U.S. Cl. CPC G06F 16/3329; G06F 16/3334; G06F 16/3344; G06F 16/338; G06N 20/00

(57) ABSTRACT

Improved methods and systems for generating natural language responses to knowledge queries are provided. In one aspect, a method is provided that includes a conversational query with questions phrased in natural language. Corresponding knowledge data may be identified that relates to the conversational query, and an inference query may be generated based on the conversational query and the knowledge data. Reduced inference query may be generated that removes at least a portion of the knowledge data from the conversational query. A natural language response may be generated based on the reduced inference query, and may be presented to a user. In certain instances, a first model may be used to generate the inference query, a second model to be used to generate the reduced inference query, and a third model may be used to generate the natural language response.

### CROSS-REFERENCES TO RELATED APPLICATIONS

The present disclosure claims priority to U.S. Provisional Patent Application No. 63/314,765 filed on Feb. 28, 2022 with the title “Natural Language Response Generation to Knowledge Queries”, which is incorporated herein by reference in its entirety.

### BACKGROUND

Any discussion of the prior art throughout the specification should in no way be considered as an admission that such prior art is widely known or forms part of the common general knowledge in the field.

Systems based on artificial intelligence (AI) that can imitate human conversations often struggle to properly imitate human behaviours. Various methods are used to measure the performance of AI in terms of producing outcomes similar to human thought patterns. The so-called Turing test is one such method to determine the performance of AI programs in terms of the aforesaid aspect. However, it is interesting to note that the modern attempts at knowledge driven conversational AIs typically struggle to pass the Turing test. Further, it is interesting to note how easily a well-implemented conversational AI is confused or fails to generate relevant responses just by introducing trivial, off-topic user dialogs. As a result, it is significantly challenging to implement reliable process automations using conversational AI technologies.

There is accordingly a need for systems or methods which address some or all of the above issues, or at least provides an alternative to conventional systems for imitating human conversations.

### SUMMARY OF THE INVENTION

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. In one aspect, a method is provided that includes receiving a conversational query that includes a questions phrased in natural language. The method also includes identifying corresponding knowledge data related to the conversational query. The method also includes generating an inference query based on the conversational query and the knowledge base using a first model, where the inference query includes at least a subset of the knowledge data. The method also includes generating, with a second model, a reduced inference query that removes at least a portion of the subset of the knowledge data. The method also includes generating a natural language response using a third model based on the reduced inference query and the processed knowledge data. The method also includes presenting the natural language response to a user. Other embodiments of this aspect include corresponding computer systems, apparatus, and computer programs recorded on one or more computer storage devices, each configured to perform the actions of the methods (e.g., using a processor and a memory storing instructions that are executed by the processor.

Additional or alternative aspects may include one or more of the following features. In one aspect, the inference query may provide a logical representation of the conversational query and associated data from the knowledge data. The context information may be predicted based on from the conversational query, the decision operation may be predicted based on the conversational query, and the argument array may be predicted based on the knowledge data. The inference query may include context information, at least one decision operation, and at least one argument. Preparing the reduced inference query may include identifying one or more invalid data entries within subset of the knowledge data and removing the one or more invalid data entries from the inference query to generate the reduced inference query. The first model may be a semantic parser model, the second model may be a post processing model, and/or the third model may be a decoder model. The semantic parser model and the post processing model may be implemented by transformer models and the third model may be implemented as a generative pre-trained model. The corresponding knowledge data may be identified from within a preexisting database of knowledge data. The corresponding knowledge data may be identified based on one or more keywords within the conversational query. The corresponding knowledge data may be received with the conversational query. Implementations of the described techniques may include hardware, a method or process, or computer software on a computer-readable medium.

A detailed description of one or more embodiments of the invention is provided below along with accompanying figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications and equivalents. For the purpose of example, numerous specific details are set forth in the following description in order to provide a thorough understanding of the present invention.

The present invention may be practiced according to the claims without some or all of these specific details. For the purpose of clarity, technical material that is known in the technical fields related to the invention has not been described in detail so that the present invention is not unnecessarily obscured.

### BRIEF DESCRIPTION OF DRAWINGS

Embodiments of the invention will now be described by way of example only with reference to the accompanying drawings.

FIGS. 1A and 1B depict exemplary architectures of the overall system of an embodiment of the present invention.

FIG. 2 illustrates a system according to an exemplary embodiment of the present disclosure.

FIG. 3 illustrates a model flow according to an exemplary embodiment of the present disclosure.

FIG. 4 illustrates a method according to an exemplary embodiment of the present disclosure.

FIG. 5 depicts a computer system according to an exemplary embodiment of the present disclosure.

### DETAILED DESCRIPTION

In the present disclosure, depiction of a given element or consideration or use of a particular element number in a particular figure or a reference thereto in corresponding descriptive material can encompass the same, an equivalent, or an analogous element or element number identified in another figure or descriptive material associated therewith. The detailed embodiments of the current invention depicted herein are merely exemplary of the current invention. They are not limited to the specific structure or details disclosed herein while serving the purpose of supporting current claims presented herein and further providing guidance to one skilled in the art to employ the present invention virtually in any form of detailed structure. Also the terms and the phrases used herein shall not be limited; but used to describe the present invention in an understandable manner. In a number of instances, known systems, methods, procedures, and components have not been described in detail so as to not unnecessarily obscure aspects of the embodiments of the present disclosure.

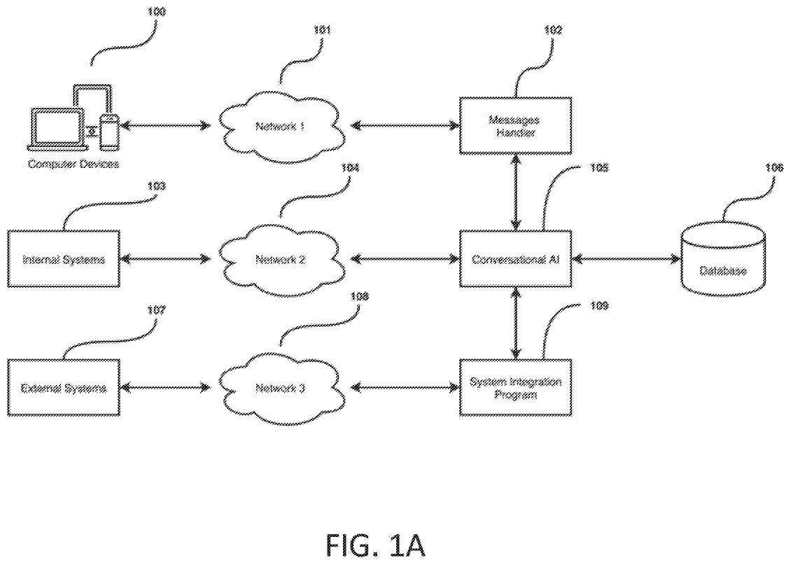

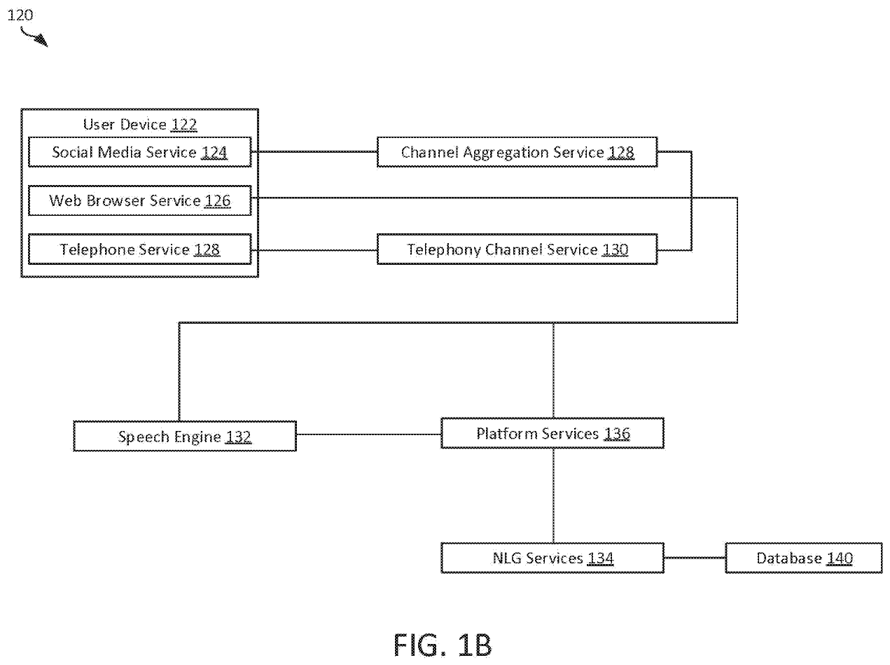

FIG. 1A is an exemplary implementation of the overall system on a computer network. Users can access the system through communication devices 100 such as but not limited to mobile phones and computers. The communication can be in the form of text or voice. System 102 handles the messages received by the devices 100, and in the case of receiving voice of a voice based communication, system 102 converts the voice into natural language text using any form of voice to text conversation technology. Output of system 102 will be in the form of text which is understood by system 105. Further, any response generated by system 105, will be forwarded back to the communication devices 100, in the form of natural voice synthesized by the system 102 or as a form of text. System 102 can be implemented in a form of single or multiple computer systems where the details are not discussed in the scope of the present invention.

The purpose of system 105 is to understand the natural language communicated by the user and reply back to the user in natural language with information or instruction derived from a predefined knowledge domain. Whenever desired, system 105 reads and writes system configurations, system logs, knowledge domain related data or other relevant data from or to database 106, which can be implemented on single or multiple computer devices.

System 109, is used by system 105 in order to read or write data from or to internal systems 103 or external systems 107. Functionality of system 109 is to format data and maintain a communication between system 105 and external or internal systems via computer networks 104 or 108. Computer networks 104 and 108 may represent any computer network that uses any form of communication techniques. System 103 and 107 can represent implementations of services such as but not limited to databases, email services and alert generating services.

FIG. 1B is an exemplary implementation of a system 200 according to an exemplary embodiment of the present disclosure. The system 200 may be configured to receive and process utterances from users. In particular, the system 200 may be configured to receive utterances from user devices 122. The user device 122 may include personal computing devices associated with one or more individual users. For example, the user device 122 may include one or more of a smartphone, tablet, laptop, wearable computing device, smart speaker, or any other personal computer.

The user device 122 includes a social media service 124, a web browser service 126, and a telephone service 128. The services 124, 126, 128 may represent different means for receiving or transmitting utterances (e.g., text utterances, audio utterances) for future processing (e.g., via the NLG system 134). The social media service 124 may include one or more social media platforms, such as Facebook, Instagram, Snapchat, Line, WhatsApp and the like. In certain instances, the social media service 124 may execute on the user device 122 and/or may execute on another computing device (e.g., a cloud computing device implemented by the social media provider). The web browser service 126 may represent a web browser executing on the user device 122 and/or may represent a computing services executing on another computing device that is accessed via the user device. The telephone service 128 may include a service capable of placing calls (e.g., via a cellular telephony network, a voice over IP (VoIP) service) capable of transmitting and receiving audio communications in real time. In certain instances, utterances may be received from additional or alternative services (e.g., an email services, an SMS service, and the like). Utterances may be received via the services 124, 126, 128. For example, audio utterances may be received via the telephone service. As another example, audio utterances may be received as digital audio files recorded on the user device 122 and transmitted to a social media service. As a still further example, text utterances may be received as text files (e.g., status updates, chat entries) entered via the web browser service 126 and/or the social media service 124.

In certain implementations, utterances may be received from the user device 122 via intermediary services. For example, the system 120 includes a channel aggregation service 128 and a telephony channel service 130. The channel aggregation service 128 may be configured to receive text or audio data from social media services 124. For example, the channel aggregation service 128 may communicate with social media services 124 according to application programming interfaces (APIs) associated with the social media services 124. In certain implementations, the channel aggregation service 128 may be implemented by one or more of Twilio, Gupshup services, and the like. In certain implementations, utterances may be received from social media services 124 and/or web browser services 126 via a WebSocket as well. The telephony channel service 130 may be configured to receive telephony communications according to one or more session initiated protocols (SIPs). For example, the telephony channel service may include one or more SIP servers configured to receive calls and connect calls to other computing services.

In certain instances, audio utterances received from the user device 122 may need to be converted into text for further processing. Accordingly, the system 120 includes a speech engine 132 that may be configured to receive audio files (e.g., of human speech) and to convert speech contained within the audio files into text files of what was said in the audio files. In certain implementations, the speech engine 132 may executed as a cloud service on a cloud computing platform (e.g., as a distributed computing service executing on multiple computing devices).

Platform services 136 may be configured to receive and process utterances. For example, the platform services 136 may receive the text output from the speech engine 132 for audio utterances received from the user device. As another example, the platform services 136 may directly receive text utterances from the user device 122 and/or from the channel aggregation service 128 and telephone channel service 130. In certain instances, the platform services 136 may receive streamed data from the user device 122, the channel aggregation service 128, telephony channel service 130, and/or the speech engine 132 via a WebSocket channel.

The platform services 136 may be configured to route received utterances between different NLG services 134 and/or different artificial intelligence models. In particular, the NLG services 134 may include different services and/or machine learning models that generate responses to different types of utterances or user queries. The platform services 136 may be configured to determine when a response is needed to a received user utterance and, when necessary, to forward the utterance to an appropriate NLG service 134 for further processing.

The NLG services 134 may be configured to generate responses to user utterances. These responses may then be transmitted to the user device 122. In certain instances, the NLG services 134 may receive the requests and user utterances as HTTP requests (e.g., JSON-based HTTP requests containing a text version of the user utterance's contents). The NLG services may be configured to generate responses to unpredictable or novel forms of user utterances. Most such queries can be successfully answered using pre-categorized knowledge bases, which may be stored on databases 140 that are communicatively coupled to the NLG services 134. In certain implementations, the NLG services 134 may include one or more machine learning models (e.g., neural network models) configured to generate responses based on pre-defined knowledge banks. Such configurations reduce the effort required to predict and hard code responses to infrequent (or unpredictable) user requests or queries. For example, the NLG services 134 may be trained using datasets such as one or more of the databases summarized in Table 1 below. In certain implementations, the NLG services 134 may be trained on datasets derived from one or more of the databases in Table 1, rather than directly from the databases themselves.

TABLE 1

| Dataset | Description | Metadata |
|---|---|---|
| Verbalization | A dataset that contains questions, | Questions, factual answers, |
| Database | factual answers, and verbalized | and verbalized answers |
| | complete answers. Verbalized | |
| | answers may embedded factual | |
| | answers into complete sentences. | |
| Paragraphs | A dataset that contains paragraph | Paragraphs, questions, and |
| Database | forms of questions and answers. The | answers. These may be |
| | paragraphs may target reading | categorized (e.g., into dates, |
| | comprehension based on discrete | numbers, strings). |
| | reasoning (e.g., additions, sorting). | |
| Abstract Meaning | A dataset that combines complete | Machine-readable |
| Database | sentences with machine readable | representations of sentences, |
| | representations of the sentence. For | such as non-core semantic |
| | example, each sentence may include | roles, within-sentence |
| | an accompanying tree-structure | coreference, named entity |
| | representing the sentence's meaning. | annotation, modality, negation, |
| | | questions, and quantities. |
| Question-Answer | A database that includes questions | Paragraphs (e.g., the body of |
| Database | regarding a specific body of | information), questions, and |
| | information (e.g., Wikipedia articles). | answers. |
| | The answer to each question may be | |
| | provided as a segment of text or a | |
| | portion of the body of information that | |
| | contains the associated information. | |

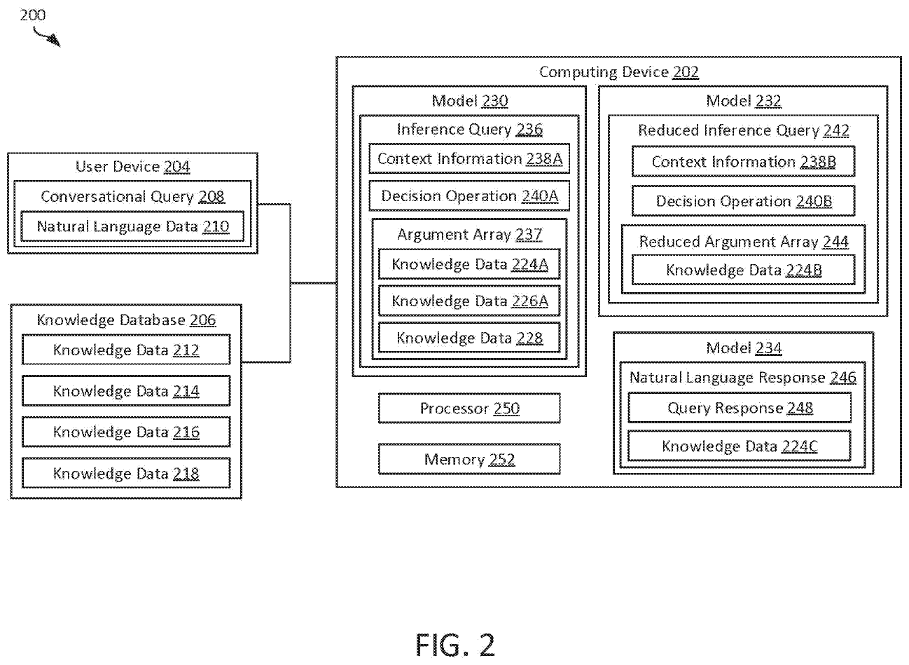

FIG. 2 illustrates a system 200 according to an exemplary embodiment of the present disclosure. The system 200 may be configured to receive and generate responses to conversational queries received from one or more users. The system 200 may be at least partially implemented by or within the systems 105, 120. For example, the system 200 may implement at least a portion of the NLG services 134 and/or other portions of the system 120. The system 200 includes a computing device 202 and a user device 204, which may be an exemplary implementation of the user device 122. The computing device 202 may be configured to receive a conversational query 208 from a user device 204. The user device 204 may be a computing device (e.g., smart phone, tablet, laptop, personal computer, wearable computing device, and/or any other computing device) associated with an individual user. The conversational query 208 may include a question, request, or other inquiry from a user. In certain instances, the conversational query 208 may be independent (e.g., may be received as a point of first interaction from the user). In other instances, the conversational query 208 may occur during a conversation with a user (e.g., a bidirectional exchanges of conversational statements between the user and the user device 204). In such instances, a question posed in the conversational query 208 may depend on or otherwise references previous statements exchanged between the user and the user device 204.

The user device 204 may receive the conversational query 208 from a user. For example, the conversational query 208 may be received as a user utterance via one or more of social media service 124, the web browser service 126, and/or the telephone service 128. In certain instances, the conversational query 208 may be received as an audio query (e.g., a spoken query) received by the user device 204 (e.g., via a microphone included within and/or communicatively coupled to the user device 204). As another example, the user device 204 may be a smart speaker or other microphone-equipped computing device that receives the conversational query 208. The conversational query 208 includes natural language data 210.

The natural language data 210 may be audio or text (e.g., alphanumeric) data reflecting the conversational query 208 received from the user. Will in instances where the conversational query 208 is received as text data (e.g., via a jackpot or other textual communication interface), the natural language data 210 may include a copy of the textual data received from the user indicative of the query. In implementations where the conversational query 208 is received as a spoken query from a user, the natural language data 210 may include a copy of the audio data containing the user's query and/or may contain a textual representation of the contents of the audio command (e.g., generated by a speech-to-text or other transcription service on the user device 204).

The computing device 202 may then receive the conversational query 208. For example, the user device 204 may transmit the conversational query 208 to the computing device 202 (e.g., along with a request for the computing device 202 to generate a response to the conversational query 208). In response, the computing device 202 may identify one or more pieces of knowledge data relevant to the conversational query 208. For example, the system 200 further includes a knowledge database 206 containing multiple knowledge data entries 212, 214, 216, 218. The knowledge data entries may include unstructured information regarding multiple topics. For example, the knowledge data entries 212, 214, 216, 218 may include image, text, audio, and/or video data concerning one or more topics. In particular, the knowledge data entries 212, 214, 216, 218 may include information regarding multiple topics that is presented in conversational or unstructured form. For instance, the knowledge data entries 212, 214, 216, 218 may include unstructured text regarding one or more topics (e.g., excerpted from relevant publications such as articles, trade journals, research papers, video discussions, audio discussions, interviews, and the like.

To identify the corresponding knowledge data, the computing device 202 may perform one or more keyword searches on the knowledge data contained within the knowledge database 206. Additionally or alternatively, the knowledge data may be received along with the conversational query 208. In still further implementations, the corresponding knowledge data may be identified by a machine learning model. As one specific example, the corresponding knowledge data may be identified by the model 230 or by another model (e.g., depicted or not depicted in FIG. 1).

The computing device 202 further includes three models 230, 232, 234. The models 230, 232, 234 may be configured to function cooperatively to process the conversational query 208, determine an answer or other response for the conversational query 208, and to generate a natural language response 246 that can be presented to a user in response to the conversational query 208 (e.g., via the user device 204). In certain implementations, the model 230 may be a semantic parser model, the model 232 may be a postprocessing model, and the model 234 may be a decoder model. In certain implementations, the models 230, 232 may be implemented by transformer models and the model 234 may be implemented by a generative pre-training model (e.g., GPT-2, GPT-3, subsequent versions of GPT, and/or similar models). It should be appreciated, however, that additional or alternative implementations of the system 200 may utilize different types of machine learning or predictive models for the models 230, 232, 234 including supervised learning models, unsupervised learning models, and other types of machine learning models. For example, the predictive models 230, 232, 234 may be implemented as one or more of a neural network, a decision tree model, a support vector machine, and/or a Bayesian network. In preferred embodiments, the predictive models 230, 232, 234 may be implemented as regression models trained on their respective data inputs.

The computing device may then generate an inference query 236 representative of the conversational query 208. In particular, the inference query 236 may be a simplified, logical representation of a question or other query presented within the conversational query 208. In particular, the inference query 236 may include context information 238A representative of a subject of the conversational query 208 (e.g., what is being asked about) and/or additional information received from a user (e.g., in previous interactions). The inference query 236 may further include a decision operation 240A representative of a condition or other logical inquiry presented within the conversational query 208. For example, the decision operation 240A may include a logical operation (e.g., less than or equal, greater than or equal, less than, greater than, maximum, minimum, addition, subtraction, sum, include, exclude, first, last, and the like) and any conditions (e.g., numerical or textual requirements). As another example, the decision operation 240A may include other types of operations (e.g., sorting, ranking, data transformation) to be performed on relevant data. The inference query 236 may further include an argument array 237 that includes knowledge data entries 224A, 226, 228. The knowledge data entries 224A, 226, 228 may be selected from among data entries identified by the computing device 202 as related to the conversational query 208. In additional or alternative implementations, the model 230 may identify the knowledge data 224A, 226, 228 within the knowledge database 206.

As one specific example, a user may be shopping for car insurance for their car. In a previous interaction (e.g., a different user query or a response to a query from the user device 204), the user may have identified their car as a 2017 Toyota Corolla. The user may then ask whether car insurance plans are available for their car that cost less than $100 per month. The context information 238A may then be generated to indicate what the user is asking about (e.g., car insurance) and/or other factual information received from the user (e.g., that the user's car is a 2017 Toyota Corolla). The decision operation 240A may indicate the user-specified condition (e.g., less than $100 per month). The argument array 237 may include knowledge data 224A, 226, 228 regarding available insurance premiums for 2017 Toyota Corollas or similar vehicles (e.g., a $70 policy, a $120 policy, and a $105 policy).

The model 232 may receive the inference query 236 and may be configured to generate a reduced inference query 242. In particular, the reduced inference query 242 may be generated to limit the knowledge data 224A, 226, 228 within the argument array 237 for better processing by the model 234 (e.g., to enable the model 234 to generate a natural language response 246 that contains only the most relevant data. In particular, the model 232 may be configured to generate the reduced inference query 242 based on the inference query 236. In particular, the model 232 may apply the decision operations 240A contained within the inference query 236 to the argument array 237 in order to identify which of the knowledge data entries 224A, 226, 228 comply with the requirements reflected within the decision operation 240a. For example, the knowledge data entries 226, 228 may not comply with the decision operation 240A (e.g., may correspond to the $120 insurance policy and the $105 insurance policy), but the knowledge data entry 224A may comply (e.g., corresponding to the $70 policy). Accordingly, the model 232 may generate a reduced argument array 244 that contains only the knowledge data entry 224B (e.g., a copy or other equivalent representation of the knowledge data entry 224A). The reduced inference array 242 may further include the decision operation 240B and context information 238B, which may be equivalent to the context information 238A and decision operation 240A included within the inference query 236.

The model 234 may then receive the reduced inference query 242 and may generate a natural language response 246 based on the reduced inference query 242. In particular, the natural language response 246 may be generated to include a query response 248 representative of an ultimate response to the conversational query 208 (e.g., yes/no answers to the conversational query, providing requested factual information). The natural language response 246 may be generated to further include knowledge data 224C, which may be equivalent to the knowledge data 224A, B. Continuing the previous example, the query response 248 may be generated to indicate that insurance policies are available for 2017 Toyota Corollas for less than $100 a month, and may identify the $70 per month policy as complying with the user's conversational query 208. The natural language response 246 may be generated to include one or more of textual data, audio data, and/or video data that present the query response 248 and knowledge data 224C in natural language phrasing (e.g., in a conversational tone). For example, the natural language response 246 may be generated to include textual or audio data that states, “Yes, such insurance policies are available for your vehicle. Insurance Corp. has a policy available that starts at $70 per month.”

The natural language response 246 may then be presented to the user. For example, the natural language response 246 may be transmitted to the user device 204, and the user device 204 may present the natural language response 246 to the user. Presenting the natural language response 246 may include displaying textual or video information associated with the natural language response 246 and/or playing back audio information associated with the natural language response 246 by the user device 204.

The computing device 202 may further be configured to train the models 230, 232, 234 in order to perform their functions as described above. Training the models 230, 232, 234 may include presenting training data to the models 230, 232, 234 associated with one or more expected outputs for the models 230, 232, 234 (e.g., expected inference queries for the model 230, expected reduced inference queries for the model 232, and expected natural language responses 246 for the model 234). Outputs produced by the models 230, 232, 234 may be compared with the expected outputs, and one or more parameters of the models 230, 232, 234 may be adjusted based on differences between the produced outputs and the expected output. In particular, the parameters may include weights (e.g., priorities) for different features and combinations of features (e.g., of received information) and updating the models 230, 232, 234 may include updating one or more of the features analyzed and the weights assigned to different features and/or combinations of features.

It should be noted that, although the computing device 202 and the user device 204 are depicted and discussed as separate computing devices, in practice, the computing device 202 and the user device 204 may be implemented by a single computing device that implements the functionality of both devices 202, 204. Additionally or alternatively, one or more functions of the computing device 204 may be implemented by the computing device 202. Similarly, in certain implementations, one or more of the functions of the computing device 202 may be implemented by the user device 204. In still further implementations, the computing device 202 and/or the user device 204 may be implemented by more than one computing device. For example, the computing device 202 may be implemented at least in part as an application executing within a distributed computing environment (e.g., a cloud computing environment) in which functions and software applications may be implemented by multiple computing devices at the same time.

The computing device 202 further includes a processor 250 and a memory 252. The processor 250 and the memory 252 may implement one or more aspects of the computing device 202. For example, the memory 252 may store instructions which, when executed by the processor 250, may cause the processor 250 to perform one or more operational features of the computing device 202 (e.g., to implement one or more of the models 230, 232, 234). The processor 250 may be implemented as one or more central processing units (CPUs), field programmable gate arrays (FPGAs), and/or graphics processing units (GPUs) configured to execute instructions stored on the memory 252. Although not depicted, the user device 204 and the knowledge database 206 may similarly include one or more processors and memories configured to implement one or more corresponding operational features. Additionally, the computing device 202, user device 204, and knowledge database 206 may be configured to communicate using a network. For example, the computing device 102 may communicate with the network using one or more wired network interfaces (e.g., Ethernet interfaces) and/or wireless network interfaces (e.g., Wi-Fi®, Bluetooth®, and/or cellular data interfaces). In certain instances, the network may be implemented as a local network (e.g., a local area network), a virtual private network, L1, and/or a global network (e.g., the Internet).

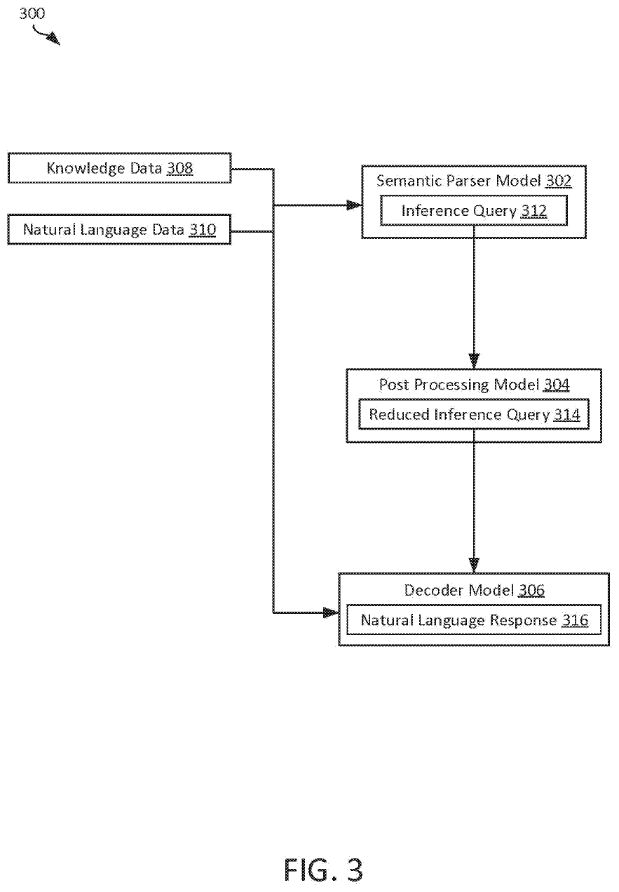

FIG. 3 illustrates a model flow 300 according to an exemplary embodiment of the present disclosure. The model flow 300 may depict a representative information flow between multiple machine learning models in order to generate a natural language response 316 to a conversational query. For example, the model flow 300 may be an exemplary implementation of the system 200. For example, the system 300 includes a semantic parser model 302, which may be an exemplary implementation of the model 230, a post processing model 304, which may be an exemplary implementation of the model 232, and a decoder model 306, which may be an exemplary implementation of the model 234.

The model flow 300 begins with receiving knowledge data 308 and natural language data 310. As explain above, natural language data 310 may be received with a conversational query from a user, and knowledge data 308 may be similar received and/or may be identified within a knowledge database. The knowledge data 308 may include relevant information for a query or other question posed within the natural language data 310. For example, a user may request whether any laptop computers are available with more than six hours battery life that cost less than $800. The knowledge data 308 may include unstructured, conversational data (e.g., contextual data from relevant publications) that discuss or otherwise indicate cost information and/or battery life information for a variety of laptop models.

The semantic parser model 302 may receive the knowledge data 308 and the natural language data 310 and may generate an inference query 312 based on the received information. As explained above, the inference query 312 may include context information (e.g., the user is asking about laptops), one or more decision operations (e.g., battery life greater than or equal to six hours, retail price less than or equal to $800), and an argument array containing one or more relevant data entries from the knowledge data 308 (e.g., a first laptop with a battery life of 5 hours in a cost of $600, a second laptop with a battery life of 7 hours in a cost of $800, a third laptop with a battery life of 6 hours and a cost of $700, and a fourth laptop with a battery life of 10 hours and a cost of $1200).

The post processing model 304 may receive the inference query 312 may generate a reduced inference query 314 based on the inference query 312. In particular, as explained above, the reduced inference query 314 may be generated by applying a decision operation from the inference query 312 to the data entries reflected within the inference query 312. For example, after applying the relevant decision operation, the reduced inference query may include indications of the second and third laptops, but may omit indications of the fourth laptop. In certain implementations, the post processing model 304 may further be configured to apply one or more pieces of relevant context information (e.g., as indicated within the inference query 312 to further limit the knowledge data entries included within the reduced inference query 314. For example, based on previous interactions with the user, the context information may indicate that the requesting user values computer battery life over absolute cost of the computer. Accordingly, the post processing model 304 may further limit the reduced inference query 314 to only include an indicator of the second laptop, which has longer battery life, and may omit an indicator of the third laptop, which costs less, but has a shorter battery life.

The decoder model 306 may then receive the reduced information query 314, along with one or both of the knowledge data 308 and the natural language data 310. The decoder model 306 may generate a natural language response 316 based on the received information. For example, the natural language response 316 may be generated to indicate that the user's requested laptops are available, and may identify the third laptop. In certain instances, the natural language data 310 may be used while generating the natural language response 316. For example, depending on how the user's question was phrased, the specific wording of the natural language response 316 generated by the decoder model 306 may differ. For example, the user may ask, as indicated by the natural language data 310, “Are there any available laptops for sale for less than $800 that have a battery life of six hours or longer?” In response, the decoder model 306 may generate the natural language response 316 to match the conversational tone and phrasing of the user. For example, the natural language response 316 may be generated to states, “Yes, there are at least two laptops for sale that cost less than $800 and have a battery life of at least six hours. One such laptop is the model XYZ, sold by Computer Corp. Would you like additional information?” Alternatively, the natural language data 310 may ask “Can you recommend a laptop I can buy for $800 or less that has a battery life of six hours or longer?” Based on this phrasing, the model 306 may generate the natural language response 316 to state, “Yes, I recommend the model XYZ, sold by Computer Corp.”

In this manner, the specific configuration of the three models 302, 304, 306 enable automated, conversational responses to user inquiries that incorporate previously-received contextual information and externally available knowledge data to generate factually correct, conversationally fluid natural language responses to received user queries. In particular, by using inference queries and reduced inference queries separate from the models that generate natural language responses, the above-described model flow 300 allows for improved generation of natural language responses by separately reducing the overall information presented to include only the most relevant information to the received user query.

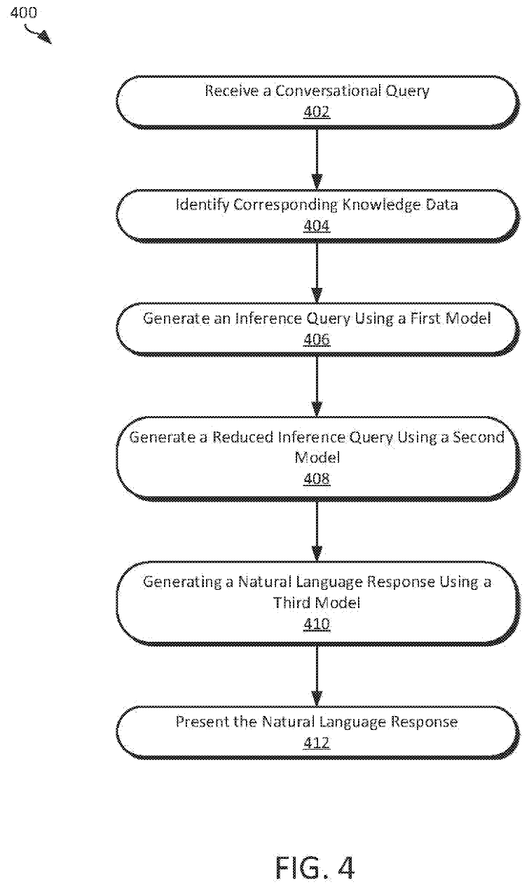

FIG. 4 illustrates a method 400 according to an exemplary embodiment of the present disclosure. The method 400 may be performed to receive and respond to conversational queries from users end user devices with natural language responses to enable conversationally fluid interactions with users. For example, the method 400 may be performed by the system 200 and/or as part of the model flow 300. The method 400 may be implemented on a computer system. For example, the method 400 may be implemented at least in part by the computing device 202. The method 400 may also be implemented by a set of instructions stored on a computer readable medium that, when executed by a processor, cause the computer system to perform the method 400. For example, all or part of the method 400 may be implemented by the processor 148 and the memory 152. Although the examples below are described with reference to the flowchart illustrated in FIG. 4, many other methods of performing the acts associated with FIG. 4 may be used. For example, the order of some of the blocks may be changed, certain blocks may be combined with other blocks, one or more of the blocks may be repeated, and some of the blocks described may be optional.

The model 400 may begin with receiving a conversational query (block 402). For example, the computing device 202 may receive a conversational query 208 from a user device 204. Conversational query 208 may be received as a textual or audio request from a user (e.g., entered or recorded via the user device 204). The user device 204 may then transmit to the conversational query 208 to the computing device 202. As explained above, the conversational query 208 may include natural language data 210 representative of the query received from the user.

Corresponding knowledge data may then be identified (block 404). For example, the computing device 202 may identify corresponding knowledge data 224, 226, 228 within a knowledge database 206. The corresponding knowledge data may concern one or more topics about which the user is asking within the conversational query 208. For example, as explained above, the corresponding knowledge data may be identified based on one or more keyword searches and/or by a machine learning model.

Inference query may generated using a first model (block 406). For example, the computing device 202 may generate an inference query 236, 312 using a first model 230, such as a semantic parser model 302. The model 230, 302 may be configured to identify context information 238 and/or a decision operation 240 contained within the conversational query 208 (e.g., within the natural language data 210) and/or within natural language data representative of earlier interactions with the user. The inference query 236, 312 may be generated to include the context information 238, the decision operation 240, and an argument array 237 including relevant knowledge data entries 224, 226, 228. In certain instances, the argument array 237 may include a reduced list of knowledge data entries identified at block 404. In additional or alternative implementations, block 404 to be performed at least in part while generating the inference query. In such instances, the argument array 237 may include all corresponding knowledge data entries identified at block 404.

The reduced inference query may be generated using a second model (block 408). For example, the computing device 202 may generate a reduced inference query 242, 314 using a second model 232, such as a post processing model 304. As explained above, the second model 232, 304 may be configured to remove one or more knowledge data entries 226, 228 from the argument array 237 in order to generate a reduced argument array 244 included within the reduced inference query. The model 232 may further remove portions of the context information 238 and/or the decision operation 240 from the inference query 236 to generate the reduced inference query 242.

A natural language response may be generated using a third model (block 410). For example, the computing device 202 may generate a natural language response 246, 316 using the third model 234, such as a decoder model 306. The natural language response 256, 316 may be generated based on the reduced inference query 314 and/or based on additional knowledge data and/or natural language data 210, 310. As explained above, the natural language response 246, 316 may be generated to match a conversational tone or phrasing of the user reflected within the natural language data 210, 310. The natural language response 246, 316 may be generated as one or more of textual data, audio data, and video data.

The natural and response may then be presented to a user (block 412). For example, the computing device 202 and/or the user device 204 may present the natural language response 246, 316 to a user. Natural language response 246, 316 may be presented by displaying or otherwise reproducing textual data, audio data, and/or video data included within the natural language response 316. For example, the language response 316 may be presented by playing back audio data contained within the natural language response 246, using one or more speakers of the user device 204.

In this manner, the method 400 enables a unique and novel arrangement of machine learning models that improve the ability for computing devices to automatically receive and respond to conversational queries from users. In particular, utilizing separate models to determine contents and relevant information for the response separately from generating the natural language response itself improves both the quality of information included within generated responses and the conversational quality and tone/phrasing of the natural language responses themselves. This improves the quality of interaction for a user and improves the information that they receive in response to their queries. Additionally, by separating out these models as separate architectural structures, each of the models may be trained and refined separately. This may reduce the overall computing resources necessary to train and improve the models, by allowing training efforts to focus on individual models to improve particular aspects (e.g., factual information, natural language phrasing) of the system, rather than trying to optimize and balance all of these within a single machine learning model. Furthermore, machine learning models (e.g., neural networks) typically struggle with multi-hop data operations (e.g., sorting, arithmetic operations). By performing these operations at different steps and with different models/techniques, it is possible to address these issues while still using machine learning techniques (e.g., to process and identify relevant knowledge data, to generate natural language responses). Furthermore, using machine learning techniques to generate natural language responses reduce the requirements for developers to determine responses to individual user queries, which both reduces developer time and allows computing systems to automatically expand the types of responses that can be generated (e.g., as model training progresses).

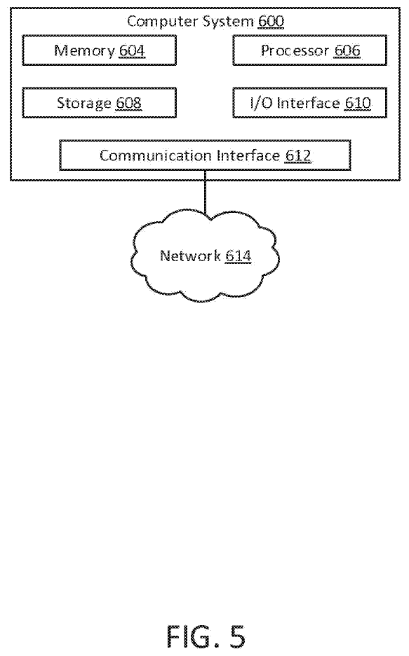

FIG. 5 illustrates an example computer system 600 that may be utilized to implement one or more of the devices and/or components discussed herein, such as the systems 100, 120, 200 and/or the model flow 300. In particular embodiments, one or more computer systems 600 perform one or more steps of one or more methods, processes, or services described or illustrated herein. In particular embodiments, one or more computer systems 600 provide the functionalities described or illustrated herein. In particular embodiments, software running on one or more computer systems 600 performs one or more steps of one or more methods described or illustrated herein or provides the functionalities described or illustrated herein. Particular embodiments include one or more portions of one or more computer systems 600. Herein, a reference to a computer system may encompass a computing device, and vice versa, where appropriate. Moreover, a reference to a computer system may encompass one or more computer systems, where appropriate.

This disclosure contemplates any suitable number of computer systems 600. This disclosure contemplates the computer system 600 taking any suitable physical form. As example and not by way of limitation, the computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, the computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 606, memory 604, storage 608, an input/output (I/O) interface 610, and a communication interface 612. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 606 includes hardware for executing instructions, such as those making up a computer program. As an example and not by way of limitation, to execute instructions, the processor 606 may retrieve (or fetch) the instructions from an internal register, an internal cache, memory 604, or storage 608; decode and execute the instructions; and then write one or more results to an internal register, internal cache, memory 604, or storage 608. In particular embodiments, the processor 606 may include one or more internal caches for data, instructions, or addresses. This disclosure contemplates the processor 606 including any suitable number of any suitable internal caches, where appropriate. As an example and not by way of limitation, the processor 606 may include one or more instruction caches, one or more data caches, and one or more translation lookaside buffers (TLBs). Instructions in the instruction caches may be copies of instructions in memory 604 or storage 608, and the instruction caches may speed up retrieval of those instructions by the processor 606. Data in the data caches may be copies of data in memory 604 or storage 608 that are to be operated on by computer instructions; the results of previous instructions executed by the processor 606 that are accessible to subsequent instructions or for writing to memory 604 or storage 608; or any other suitable data. The data caches may speed up read or write operations by the processor 606. The TLBs may speed up virtual-address translation for the processor 606. In particular embodiments, processor 606 may include one or more internal registers for data, instructions, or addresses. This disclosure contemplates the processor 606 including any suitable number of any suitable internal registers, where appropriate. Where appropriate, the processor 606 may include one or more arithmetic logic units (ALUs), be a multi-core processor, or include one or more processors 606. Although this disclosure describes and illustrates a particular processor, this disclosure contemplates any suitable processor.

In particular embodiments, the memory 604 includes main memory for storing instructions for the processor 606 to execute or data for processor 606 to operate on. As an example, and not by way of limitation, computer system 600 may load instructions from storage 608 or another source (such as another computer system 600) to the memory 604. The processor 606 may then load the instructions from the memory 604 to an internal register or internal cache. To execute the instructions, the processor 606 may retrieve the instructions from the internal register or internal cache and decode them. During or after execution of the instructions, the processor 606 may write one or more results (which may be intermediate or final results) to the internal register or internal cache. The processor 606 may then write one or more of those results to the memory 604. In particular embodiments, the processor 606 executes only instructions in one or more internal registers or internal caches or in memory 604 (as opposed to storage 608 or elsewhere) and operates only on data in one or more internal registers or internal caches or in memory 604 (as opposed to storage 608 or elsewhere). One or more memory buses (which may each include an address bus and a data bus) may couple the processor 606 to the memory 604. The bus may include one or more memory buses, as described in further detail below. In particular embodiments, one or more memory management units (MMUs) reside between the processor 606 and memory 604 and facilitate accesses to the memory 604 requested by the processor 606. In particular embodiments, the memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory implementations, this disclosure contemplates any suitable memory implementation.

In particular embodiments, the storage 608 includes mass storage for data or instructions. As an example and not by way of limitation, the storage 608 may include a hard disk drive (HDD), a floppy disk drive, flash memory, an optical disc, a magneto-optical disc, magnetic tape, or a Universal Serial Bus (USB) drive or a combination of two or more of these. The storage 608 may include removable or non-removable (or fixed) media, where appropriate. The storage 608 may be internal or external to computer system 600, where appropriate. In particular embodiments, the storage 608 is non-volatile, solid-state memory. In particular embodiments, the storage 608 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 608 taking any suitable physical form. The storage 608 may include one or more storage control units facilitating communication between processor 606 and storage 608, where appropriate. Where appropriate, the storage 608 may include one or more storages 608. Although this disclosure describes and illustrates particular storage, this disclosure contemplates any suitable storage.

In particular embodiments, the I/O Interface 610 includes hardware, software, or both, providing one or more interfaces for communication between computer system 600 and one or more I/O devices. The computer system 600 may include one or more of these I/O devices, where appropriate. One or more of these I/O devices may enable communication between a person (i.e., a user) and computer system 600. As an example and not by way of limitation, an I/O device may include a keyboard, keypad, microphone, monitor, screen, display panel, mouse, printer, scanner, speaker, still camera, stylus, tablet, touch screen, trackball, video camera, another suitable I/O device or a combination of two or more of these. An I/O device may include one or more sensors. Where appropriate, the I/O Interface 610 may include one or more device or software drivers enabling processor 606 to drive one or more of these I/O devices. The I/O interface 610 may include one or more I/O interfaces 610, where appropriate. Although this disclosure describes and illustrates a particular I/O interface, this disclosure contemplates any suitable I/O interface or combination of I/O interfaces.

In particular embodiments, communication interface 612 includes hardware, software, or both providing one or more interfaces for communication (such as, for example, packet-based communication) between computer system 600 and one or more other computer systems 600 or one or more networks 614. As an example and not by way of limitation, communication interface 612 may include a network interface controller (NIC) or network adapter for communicating with an Ethernet or any other wire-based network or a wireless NIC (WNIC) or wireless adapter for communicating with a wireless network, such as a Wi-Fi network. This disclosure contemplates any suitable network 614 and any suitable communication interface 612 for the network 614. As an example and not by way of limitation, the network 614 may include one or more of an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a Bluetooth® WPAN), a WI-FI network, a WI-MAX network, a cellular telephone network (such as, for example, a Global System for Mobile Communications (GSM) network), or any other suitable wireless network or a combination of two or more of these. Computer system 600 may include any suitable communication interface 612 for any of these networks, where appropriate. Communication interface 612 may include one or more communication interfaces 612, where appropriate. Although this disclosure describes and illustrates a particular communication interface implementations, this disclosure contemplates any suitable communication interface implementation.

The computer system 602 may also include a bus. The bus may include hardware, software, or both and may communicatively couple the components of the computer system 600 to each other. As an example and not by way of limitation, the bus may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-PIN-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these buses. The bus may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

Throughout this specification and the claims that follow, unless the context requires otherwise, the words ‘comprise’ and ‘include’ and variations such as ‘comprising’ and ‘including’ will be understood to imply the inclusion of a stated integer or group of integers but not the exclusion of any other integer or group of integers.

1. A method comprising:
receiving a conversational query that includes a questions phrased in natural language;
identifying corresponding knowledge data related to the conversational query;
generating an inference query based on the conversational query and the knowledge base using a first model, wherein the inference query includes at least a subset of the knowledge data;
generating, with a second model, a reduced inference query that removes at least a portion of the subset of the knowledge data;
generating a natural language response using a third model based on the reduced inference query and the subset of the knowledge data; and
presenting the natural language response to a user.

2. The method of claim 1, wherein the inference query provides a logical representation of the conversational query and associated data from the knowledge data.

3. The method of claim 1, wherein the inference query includes context information, at least one decision operation, and at least one argument.

4. The method of claim 2, wherein the context information is predicted based on the conversational query, the decision operation is predicted based on the conversational query, and the argument array is predicted based on the knowledge data.

5. The method of claim 1, wherein preparing the reduced inference query includes:
identifying one or more invalid data entries within subset of the knowledge data; and
removing the one or more invalid data entries from the inference query to generate the reduced inference query.

6. The method of claim 1, wherein the first model is a semantic parser model, the second model is a post processing model, and/or the third model is a decoder model.

7. The method of claim 6, wherein the semantic parser model and the post processing model are implemented by transformer models and the third model is implemented as a generative pre-trained model.

8. The method of claim 1, wherein the corresponding knowledge data is identified from within a preexisting database of knowledge data.

9. The method of claim 1, wherein the corresponding knowledge data is identified based on one or more keywords within the conversational query.

10. The method of claim 1, wherein the corresponding knowledge data is received with the conversational query.

11. A system comprising:
a processor; and
a memory storing instructions which, when executed by the processor, cause the processor to:
receive a conversational query that includes a questions phrased in natural language;
identify corresponding knowledge data related to the conversational query;
generate an inference query based on the conversational query and the knowledge base using a first model, wherein the inference query includes at least a subset of the knowledge data;
generate, with a second model, a reduced inference query that removes at least a portion of the subset of the knowledge data;
generate a natural language response using a third model based on the reduced inference query and the subset of the knowledge data; and
present the natural language response to a user.

12. The system of claim 11, wherein the inference query provides a logical representation of the conversational query and associated data from the knowledge data.

13. The system of claim 11, wherein the inference query includes context information, at least one decision operation, and at least one argument.

14. The system of claim 12, wherein the context information is derived from the conversational query, the decision operation is predicted based on the conversational query, and the argument array is predicted based on the knowledge data.

15. The system of claim 11, wherein the instructions further cause the processor, while preparing the reduced inference query, to:
identify one or more invalid data entries within subset of the knowledge data; and
remove the one or more invalid data entries from the inference query to generate the reduced inference query.

16. The system of claim 11, wherein the first model is a semantic parser model, the second model is a post processing model, and/or the third model is a decoder model.

17. The system of claim 16, wherein the semantic parser model and the post processing model are implemented by transformer models and the third model is implemented as a generative pre-trained model.

18. The system of claim 11, wherein the corresponding knowledge data is identified from within a preexisting database of knowledge data.

19. The system of claim 11, wherein the corresponding knowledge data is identified based on one or more keywords within the conversational query.

20. The system of claim 11, wherein the corresponding knowledge data is received with the conversational query.
